(19) United States
(12) Patent Application Publication
(10) Pub. No.: US 2015/0217336 A1
(43) Pub. Date: Aug. 6, 2015

(54) METHOD FOR CLEANING AND/OR DESCALING A SLAB OR A PRELIMINARY STRIP BY MEANS OF A DESCALING DEVICE, AND DESCALING DEVICE

(71) Applicant: SMS Siemag Aktiengesellschaft, Düsseldorf (DE)

(72) Inventor: Jürgen Seidel, Kreuztal (DE)

(21) Appl. No.: 14/420,862

(22) PCT Filed: Aug. 7, 2013
(86) PCT No.: PCT/EP2013/066517

§ 371 Date: Feb. 10, 2015

(30) Foreign Application Priority Data
Aug. 10, 2012 (DE) 10 2012 214 298.3

(51) Int. Cl. B08B 3/04

(52) U.S. Cl. CPC B08B 3/041

(57) ABSTRACT

A method for cleaning and/or descaling a slab or a preliminary strip by a descaling device that has a nozzle, through which pressurized water is discharged onto the surface of the slab strip. The outlet of the nozzle is rectangular, or is slit-shaped and has an arcuate course at least in some sections, in the direction normal to the surface of the slab or strip, such that the water is discharged as a continuously strip-shaped jet across the entire width of the slab or strip. The width of the outlet of the nozzle in a conveying direction of the slab or strip is between 0.2 mm and 1.5 mm. The water is fed to the nozzle at a pressure between 5 bar and 50 bar. The distance between the outlet of the nozzle and the surface of the slab or strip is between 8 mm and 50 mm.

The invention relates to a method for cleaning and/or descaling a slab or a preliminary strip by means of a descaling device, wherein the descaling device displays at least one nozzle by way of which water under pressure is deployed onto the surface of the slab or of the preliminary strip. The invention furthermore relates to a descaling device.

Descaling devices are required for cleanly removing the primary or secondary mill scale, wherein in a generic descaling device water having an adequately high water pressure is deployed onto the slab to be cleaned.

The energy consumption of a descaling device, for example a finishing rolling mill descaling device, is significant here. Depending on the pressure level set and the amount of water per unit of time, the energy consumption may be up to 4.5 MW. A maximum water pressure of 380 bar, for example, is employed here. Reduction of the energy consumption is directly linked to lowering the water pressure, so that the quality of the descaling or cleaning result, respectively, then declines.

Descaling devices in various design embodiments are disclosed in DE 693 14 275 T2, in WO 2009/056712 A2, in JP 59 076 615 A, and in JP 2010 247 228 A.

Here, water is deployed onto the surface of the slab or the items to be rolled, respectively, by way of a number of nozzles which are disposed beside one another. Installations of this type have approx. 50 nozzles which are disposed beside one another per beam, for example.

According to the known solutions, an adequately large spacing between the nozzle outlet and the slab to be descaled is provided here. This is a result of the sensitivity with respect to clean overlapping of the individual nozzles increasing in particular in the case of a longitudinal or transverse curvature of the slab. Furthermore, the nozzles cannot be mounted or disposed in any arbitrary tight manner, respectively, so that adjacent nozzles are disposed so as to be offset in relation to one another. On account of water running off, jets of the individual nozzles thus interfere with one another. Furthermore, in the case of small spacing between the nozzle outlet and the slab surface, measures for securely threading the tip of the slab into the descaling device may be required where applicable. Moreover, there is also a limit to the arbitrary increase in the number of nozzles for cost reasons.

US patent U.S. Pat. No. 4,617,815 disclosed a method for cleaning and/or descaling a slab or a preliminary strip by means of a descaling device, wherein the descaling device displays at least one rectangular nozzle by way of which water under pressure is deployed onto the surface of the slab or of the preliminary strip.

The invention is thus based on the object of proposing a method of the type mentioned at the outset and a descaling device by way of which a good descaling or cleaning result, respectively, is achievable, wherein, however, at the same time significantly less energy is required. Furthermore, the temperature losses of the slab or of the preliminary strip are to be reduced.

The achievement of this object by way of the invention is characterized according to the method in that the outlet of the nozzle, when viewed in the normal direction onto the surface of the slab or of the preliminary strip, is implemented so as to be rectangular (rectangular nozzle) or configured so as to be slot-shaped, having at least in portions a curved profile, such that the water is deployed as a continuously strip-shaped jet across the entire width of the slab or of the preliminary strip, wherein the width of the outlet of the nozzle in the conveying direction of the slab or of the preliminary strip is selected so as to be between 0.2 mm and 1.5 mm, wherein the water is supplied to the nozzle at a pressure between 5 bar and 50 bar, and wherein the spacing between the outlet of the nozzle and the surface of the slab or of the preliminary strip is selected so as to be between 8 mm and 50 mm, preferably between 8 mm and 35 mm.

The width of the outlet of the nozzle in the conveying direction of the slab or of the preliminary strip preferably is selected so as to be between 0.3 mm and 0.8 mm, particularly preferably between 0.4 mm and 0.6 mm.

The water is supplied to the nozzle preferably at a pressure between 10 bar and 40 bar, in particular between 15 bar and 35 bar.

The spacing between the outlet of the nozzle and the surface of the slab or of the preliminary strip preferably is selected so as to be between 10 mm and 30 mm, in particular between 15 mm and 20 mm.

The flow conditions at the outlet of the rectangular nozzle are conceived or dimensioned such, respectively, that a compact, comparatively smooth jet having a high water speed at the outlet is created there. Despite low pressure, in comparison with a conventional flat-jet nozzle, the absence of fanning of the water jet transversely to the conveying direction in the case of the rectangular nozzle causes high impingement by shock (impact) and thus a good uniform descaling result.

The combination of the mentioned data surprisingly has lead to a very good cleaning and descaling result, respectively, wherein the energy requirement has significantly dropped.

The strip-shaped jet preferably is aligned in a fixedly adjusted manner against the conveying direction of the slab or of the preliminary strip at an angle between 0° and 30°, preferably between 15° and 25°, to the normal direction onto the surface of the slab or of the preliminary strip or implemented so as to be readjustable within the mentioned angular range.

The alignment of the jet can be fixedly adjusted in an optimal manner within the mentioned angular range of 0° to 30°, depending on the run-off conditions of the water, of the space conditions, or of the slab dimensions. Alternatively, readjustment of the angle by way of a readjustment element is also possible, depending on the above-mentioned conditions. On the lower side of the slab or of the preliminary strip, an angle of 0° may also be advantageous, for example in order to maximize the applied impulse (impact).

A refinement provides that delimiting edges are adjusted to various spacings from the surface of the slab or of the preliminary strip by nozzle plates defining the outlet of the nozzle.

The proposed descaling device for cleaning and/or descaling a slab or a preliminary strip is distinguished according to the invention in that the outlet of the nozzle, when viewed in the normal direction onto the surface of the slab or of the preliminary strip, is implemented so as to be rectangular or configured so as to be slot-shaped, having at least in portions a curved profile, wherein the width of the outlet of the nozzle in the conveying direction of the slab or of the preliminary strip is between 0.2 mm and 1.5 mm, and wherein the moving means are available by way of which the spacing between the outlet of the nozzle and the surface of the slab or of the preliminary strip is adjustable.

Here, according to a preferred design embodiment of the invention, the nozzle is accommodated in a housing which is pivotable about an axis which is disposed so as to be horizontal and transverse to the conveying direction of the slab or of the preliminary strip. A portion or protrusion, which in the intended use of the descaling device is disposed so as to be closer to the surface of the slab or of the preliminary strip than the outlet of the nozzle, may be disposed on the housing. This enables the nozzle to be effectively protected.

The outlet of the nozzle may be formed by two nozzle plates which are disposed so as to be adjacent to one another and which are preferably ruler-shaped. Here, at least one of the nozzle plates may be disposed so as to be readjustable in the conveying direction of the slab or of the preliminary strip and/or in the normal direction onto the surface of the slab or of the preliminary strip and/or transversely to the conveying direction of the slab or of the preliminary strip.

A further embodiment of the invention provides that the outlet of the nozzle is formed by two ruler-shaped nozzle plates which are disposed so as to be adjacent to one another, wherein the two nozzle plates display delimiting edges for the passage of water, which, when viewed in the normal direction onto the surface of the slab or of the preliminary strip, run at a lip angle, preferably between 1° and 5°, to the horizontal direction, transversely to the conveying direction of the slab or of the preliminary strip, and wherein the two nozzle plates are configured so as to be readjustable in relation to one another in the horizontal direction, transversely to the conveying direction of the slab or of the preliminary strip. This enables the size of the nozzle gap to be modified in a simple manner.

Instead of straight nozzle-plate edges, the edges may be provided with any arbitrary contour, in particular with a contour according to a polynomial of the nth order, such that, for example, a parabolic gap modification results across the width—similar to that in CVC technology. A refinement accordingly provides that the outlet of the nozzle is formed by two nozzle plates of arbitrary contour, wherein the two nozzle plates can be readjusted in relation to one another such that the gap width across the width of the slab or of the preliminary strip is modified in a non-uniform manner.

Here, the nozzle-gap width across the width of the slab or of the preliminary strip to be descaled may also be made to be adjustable in portions; insofar it is accordingly provided that the width of the outlet of the nozzle is adjustable in portions in the conveying direction across the width of the slab or of the preliminary strip.

The descaling device preferably displays at least one filter element which displays a multiplicity of bores, meshes, or slots, wherein the bore diameter, the mesh aperture, or the slot width is smaller than or of the same size as the width of the outlet of the nozzle. A filter of which the mesh size is smaller than the slot width of the nozzle is thus preferably disposed in the water supply. The filter element here may be disposed in front of the outlet region of the nozzle, wherein the sum of the cross-sectional area of the bores, meshes, or slots in the filter element is larger than the cross section of the outlet of the nozzle.

Here, the supply lines to the descaling device and/or the housing of the descaling device and/or all water-bearing construction parts are preferably composed of a rust-proof material (preferably steel or else copper).

Congestion of the tight rectangular nozzle is thus avoided by way of a correspondingly constructed filter unit within the housing of the descaling device. For example, this here may be a rectangular-block shaped continuous filter unit across the width (or one having a similar spatial extent), which is disposed in front of the outlet duct. The filter region here may project into the distributor duct. The filter unit is provided with small meshes or bores, or preferably with narrow slots, the bore width, mesh width or slot width of which is smaller than or of the same width as the outlet width of the rectangular nozzle. Furthermore, the sum of the cross-sectional area of the bores, meshes, or slots (when viewed in the direction of water flow) is implemented so as to be larger than the cross section of the rectangular nozzle, in order to keep the flow losses low.

A further advantageous refinement provides that the outlet of the nozzle is formed by two plates of a corresponding contour which, when displaced in relation to one another, modify the gap across the width of the slab or of the preliminary strip.

It may be provided that only one spray row—preferably with a low amount of water—is employed. The temperature of the furnace may be reduced by the temperature differential which results on account of the lower cooling effect during descaling.

The rectangular nozzle unit may be composed of the following components: a water-supply region, if applicable a filter plate, a jet director, a nozzle compensation path, a jet concentration in front of the nozzle gap, and a nozzle gap.

The delimiting edges of the two nozzle plates may also be disposed at a variable spacing from the slab or from the preliminary strip, respectively, or be adjusted to such a variable spacing, respectively.

The rectangular gap may also be configured so as to be curved. The nozzle-gap width may also be adjustable in portions across the width of the nozzle.

The nozzle in the outflow direction of the water can display a conical outlet gap or a parallel outlet gap, wherein the length of the outlet gap, when measured in the outflow direction of the water, preferably is less than 20 mm and/or longer than the triple width of the outlet of the nozzle.

The invention thus proposes a combination of various measures in order to achieve a good descaling result at significantly reduced energy consumption.

The spacing between the outlet of the rectangular nozzle and the surface of the slab or items to be rolled, respectively, is preferably 20 mm, wherein the range between 10 mm and 30 mm also shows very good results. It particularly advantageous that by using a rectangular nozzle, small spacings from the slab or from the preliminary strip, respectively, can be adjusted without the nozzle coverage across the width being relevant, since this is a rectangular nozzle.

Since a uniform descaling effect across the width can be adjusted already with one rectangular nozzle, one descaling beam per side is adequate in most cases.

The pressure level preferably is maintained at 25 bar, wherein values between 10 bar and 40 bar also lead to good results. On account thereof, significant energy savings result.

The slot width of the rectangular nozzle preferably is adjusted to 0.5 mm; the preferred value range therefor is between 0.3 and 0.8 mm.

At that comparatively low pressure and suitable gap width a low amount of descaling water is adjustable, reducing the cooling effect of the slab or preliminary strip.

The nozzle plates may be conceived to be replaceable. They preferably are composed of heat-resistant stainless steel, tempered steel, carbide metal, or ceramic.

The angle of the jet of the nozzle preferably is adjusted so as to be so steep that all water runs counter to the running direction of the belt; here, an angle between 0° and 25° is preferable.

The descaling device preferably is disposed ahead of the finishing rolling mill or behind the slab furnace.

On account of the adjustability of the spacing between the nozzle outlet and the slab surface, not only is optimization of the descaling process possible, but also protection of the nozzle when there is a change in the slab thickness. When the head of the preliminary strip or slab, respectively, is conveyed through the descaling device and the nozzle region thereof, the nozzle can be raised somewhat, or in the event of an outside force the nozzle deflects on its pivotable housing, on account of which damage can be avoided. Accordingly, the descaling device beam having the rectangular nozzle preferably is mounted in a swing arm.

As an additional measure for protecting the nozzle and for increasing the reliability of conveying, a preliminary-strip or slab head recognition device (ski) may be provided in front of the descaling device (an optical or mechanical system), and the nozzle position on the head of the slab or of the strip, respectively, may be controlled thereby.

The gap width of the rectangular nozzle may be modified by replacing the nozzle plates. It is also possible to vary the gap width by way of a readjustment mechanism (for example, by way of a cam or a wedge); to this end, a nozzle plate may be disposed in a displaceable manner. On account thereof it becomes possible for the wear of the nozzle plates to be compensated for. On account thereof it furthermore becomes possible for the gap to be opened, for example for potential nozzle cleaning.

As a further refinement, it may be provided that the gap of the nozzle is also only modified in portions across the width of the rectangular nozzle (transversely to the conveying direction of the slab). This allows the nozzle gap to be closed off in portions, on account of which adapting the width to various slab widths becomes possible.

The descaling pressure according to the invention is thus substantially reduced in comparison with the prior art, wherein on account of the proposed combination of features a largely constant descaling result nevertheless is achieved.

As the spacing between the nozzle and the items to be rolled undergoing descaling decreases, the impact pressure of the water jet on the slab surface and thus the cleaning effect increase. The invention thus operates using a decrease in the spacing and of the water pressure, while maintaining a similar descaling quality.

The spacing between the nozzle outlet and the slab surface may be adjusted by way of a corresponding actuator. In order to be able to adjust a small spacing between the nozzle outlet and the slab, an adjustment of the nozzle spacing from the item to be rolled at the head may optionally be required. The employment of the provided rectangular nozzle is advantageous here, since a uniform descaling effect or cooling effect, respectively, is caused across the width of the slab independently of the spacing. This also applies in the case of a curved surface of the items to be rolled.

On account of the reduction of the spacing between the nozzle outlet and the slab surface in the manner explained, the required amount of water per time unit can be substantially lowered. This reduces the cooling effect of the slab or of the preliminary strip. The lower cooling effect may thus be used for energy savings in that the furnace temperature (heating effect) is reduced, for example.

Instead of employing conventional nozzles, the invention provides a rectangular nozzle by way of which a water curtain can be generated and directed onto the slab to be descaled.

If a multiplicity of nozzles which are disposed beside one another were to be employed in a conventional manner, obviously more nozzles would have to be employed in the case of the reduced spacing between the nozzle outlet and the slab, according to the invention, in order to be able to ensure adequate coverage at the same spraying angle. Alternatively, the spraying angle could also be enlarged while maintaining the same spray angle; however, this would have the disadvantage of the impact pressure being reduced and the descaling result thus being negatively influenced on account thereof.

The proposed design embodiment is distinguished by a cost-effective concept. This applies, on the one hand, to the potential use of low-pressure pumps; furthermore, more reasonably priced pipelines and spray beams having thinner walls may be employed. The protective shield against employed high pressure also becomes less complex. Furthermore, wear of the rectangular nozzle is reduced on account of the lower pressure. On account thereof, a lower maintenance effort is also required.

Also, the supply lines to the descaling device and/or the descaling-device housing or at least all construction parts in water-bearing regions can be implemented in a rust-proof material (for example, stainless steel, casting, copper), since this is not a high-pressure descaling device requiring resistance to high pressure, but only pressures below 50 bar are involved. A potential risk of congestion of the tight slot nozzle can also be effectively countered in this manner. There is then indeed no occurrence of rust within the supply lines or the descaling device.

The descaling device advantageously also occupies a smaller construction space, since only one nozzle row per side has to be provided for the descaling device.

In an advantageous manner, reduced cooling of the slab as a consequence of a smaller wetted surface, or on account of the lower volumetric flow of water which is required for descaling, respectively, results.

The surface of the descaling device on the upper side which is wetted with water may additionally be delimited by pinch rollers or consolidation rollers ahead of and/or behind the descaling device. The consolidation rollers here are adjusted to a defined force or to a defined gap, respectively. Furthermore, proven drainage channels for “skimming off” the water may also be disposed in this construction of the descaling device.

On account of the rectangular nozzle which is deployed, optimal coverage of the slab across the width results, specifically in the case of a variable spacing between the nozzle exit and the slab surface.

On account of the employment of the proposed rectangular nozzle having the mentioned specification of operational parameters, the impact pressure is maintained so as to be at least as high as in the case of known high-pressure nozzles.

The outlet duct of the nozzle may be configured in the shape of a pointed slot nozzle in the outlet region. Alternatively, a nozzle having a slightly conical or preferably parallel outlet gap with a gap length of less than 20 mm and/or longer than the triple outlet gap width of the nozzle is also employable.

In as far as presently mention is made of a slab or of a preliminary strip, this generally applies to any type of slab (thin slab, thick slab) or preliminary strip or strip, respectively, and generally to any item to be descaled having a preferably rectangular cross section.

Exemplary embodiments of the invention are illustrated in the drawing, in which:

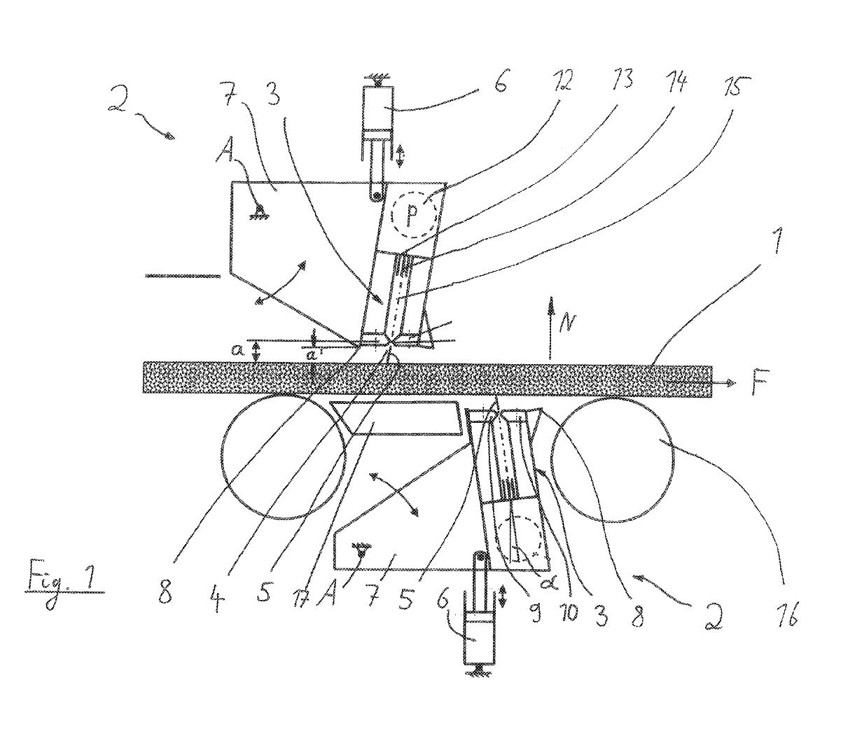

FIG. 1, in a schematic manner, shows the side view of a descaling device having one nozzle which is disposed above a slab and one nozzle which is disposed below the slab,

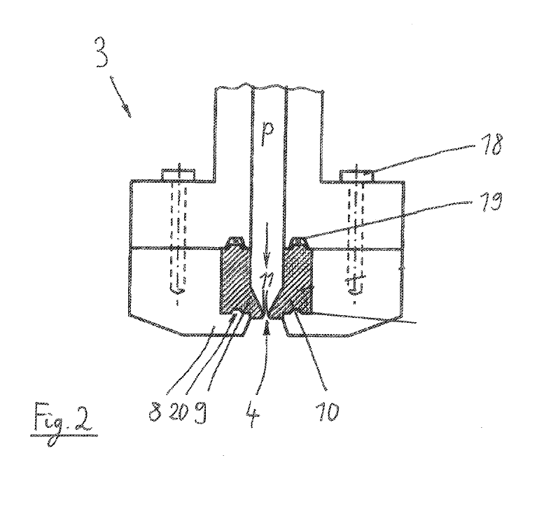

FIG. 2, in a schematic manner, shows the side view of a nozzle of the descaling device according to a first embodiment of the invention,

FIG. 3, in a schematic manner, shows the side view of a nozzle of the descaling device according to a second embodiment of the invention,

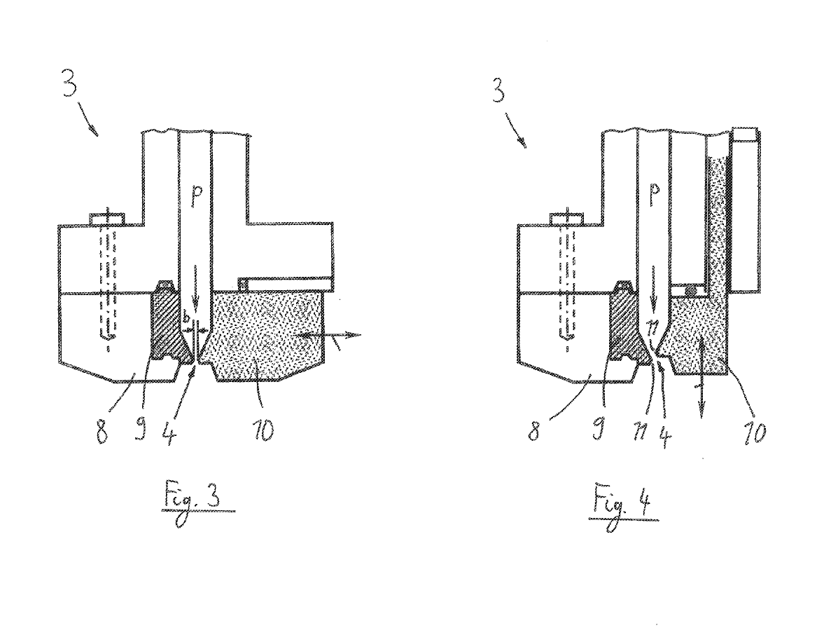

FIG. 4, in a schematic manner, shows the side view of a nozzle of the descaling device according to a third embodiment of the invention,

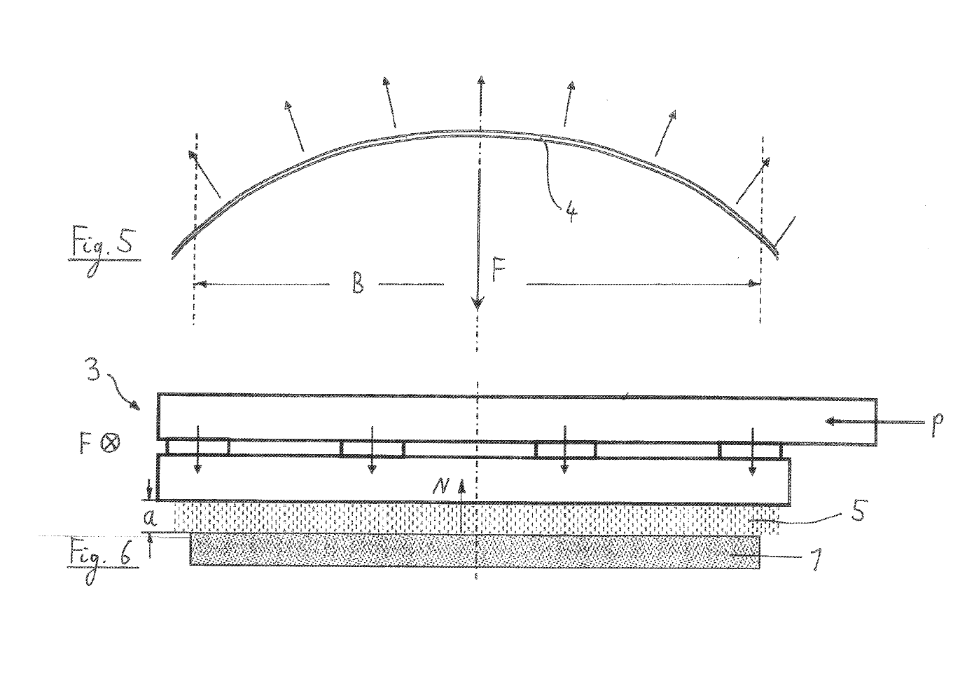

FIG. 5 shows the view onto an outlet of a nozzle, configured in a curved manner, of the descaling device, in a normal view onto the surface of the slab, and

FIG. 6 shows the nozzle as per FIG. 5, when viewed in the conveying direction of the slab.

A descaling device 2 by way of which a slab 1 is descaled on the upper side and the lower side thereof is schematically illustrated in FIG. 1. Accordingly, in each case one nozzle 3 is disposed above and below the slab 1. The slab 1 moves past the descaling device 2 in the conveying direction F.

As can be seen when viewing FIGS. 2 to 4 together, each nozzle 3 has an outlet 4 from which water is deployed under pressure. The nozzle 3 is a nozzle which deploys a jet 5 in the form of a water curtain across the width B of the slab 1 (refer to FIG. 5 in this case), that is to say that the nozzle gap at the outlet 4 is a rectangular gap (rectangular nozzle cross section) which extends horizontally and transversely to the conveying direction F across the entire width B of the slab 1.

The nozzle 3 is accommodated in a housing 7. The housing 7 is pivotably mounted on an axis A which is aligned so as to be horizontal and transverse to the conveying direction F. A moving means 6 allows the movement of the housing 7 and thus the upward and downward movement of the nozzle 3 and thus of the nozzle outlet 4. The nozzle outlet 4 can thus be moved in the normal direction N onto the slab surface. The spacing a which is present between the outlet 4 of the nozzle 3 and the surface of the slab 1 can be adjusted in this manner.

It can be furthermore identified in FIG. 1 that a portion or protrusion 8, respectively, is disposed on the housing 7. This portion protrudes beyond the nozzle outlet 4 and thus represents a protection for the nozzle 3. Accordingly, a spacing a′ between the lower edge of the portion or of the protrusion 8, respectively, and the surface of the slab 1, which is smaller than the spacing a between the outlet 4 of the nozzle 3 and the slab surface, is present.

It can be furthermore identified that the jet 5 which exits from the nozzle 3 is aligned counter to the normal direction N onto the slab 1 at an angle a (see FIG. 1, bottom). The alignment here is oriented so as to be counter to the conveying direction F.

The water is supplied to the nozzle 3 via a supply line 12 at a pressure p. Behind a filter plate 13 the water makes its way into a jet director 14 which is composed of grid plates. From here, the water makes its way into a nozzle straightener path 15.

The rectangular nozzle unit is thus composed of the following major components: a water-supply region 12, optionally a filter plate 13, a jet director 14, a nozzle straightener path, a jet concentrator in front of the nozzle gap, and finally the nozzle gap.

A potential embodiment for the filter unit 13 within the descaling-device housing 7 or the descaling device 2, respectively, is illustrated in FIG. 1. This embodiment is, for example, a rectangular-block shaped continuous filter unit 13 which extends across the width and which is bowl-shaped and disposed in front of the rectangular nozzle outlet region 14, 15. Here, the filter projects into the distributor duct 21. The filter housing or the filter unit 13, respectively, is provided with a multiplicity of narrow slots (not visible in FIG. 1), the slot width of which is smaller than or the same width as the outlet width b of the rectangular nozzle 3. Furthermore, the sum of the cross-sectional area of the bores, meshes, or preferably slots is larger than the outlet cross-section 4 of the rectangular nozzle 3. The water thus flows from the supply line 12 into a type of distributor duct 21, and onward through a multiplicity of slots of the filter unit 13 into the actual nozzle supply, having the jet director 14 and the nozzle-straightener path 15, and finally to the nozzle outlet 4.

Just like the nozzle plates 9, 10, the filter unit 13 and the jet director 14 may be easily replaced for potential maintenance purposes (for example by way of a movement in the direction of the outlet of the nozzle 4).

The supply line 12 to the descaling device 2 and/or the descaling-device housing 7, or at least all construction parts (for example, the jet director 14 and the nozzle-straightener path 15) in the water-bearing region, respectively, may be implemented in a rust-proof material. A risk of congestion of the tight slot nozzle in the nozzle gap 4 can also be effectively countered in this manner. There is then no occurrence of rust within the supply line 12 or the descaling device 2.

The nozzle gap per se is formed by two nozzle plates 9 and 10, which in each case have delimiting edges 11 (see FIG. 4). The delimiting edges 11 of the two sides may be disposed on different levels (spacing a from the slab 1) so as to be readjustable or non-readjustable. The nozzle plates may be configured so as to be replaceable.

The outlet duct 4 of the nozzle 3 may be configured in the form of a pointed slot nozzle in the outlet region (i.e. without a parallel outlet gap, for example), as is indicated in FIG. 1, for example. Alternatively, a nozzle having a parallel outlet gap, such as is formed in FIG. 4 by means of the two parallel-running delimiting edges 11, for example, is also employable.

The rectangular nozzle outlet 4 has an outlet area which is the result of the product of the width b of the outlet 4 of the nozzle 3 in the conveying direction F (see FIG. 3) and the width of the nozzle gap horizontal and transverse to the conveying direction F.

Conveyor rollers (roller table rollers) 16 are also illustrated in FIG. 1. Consolidation rollers may also be disposed on the upper side—above the conveyor roller—such that the roller pair may be effective as pinchers. A deflection plate 17 is also indicated in FIG. 1.

A nozzle 3 is illustrated in more detail in FIG. 2. Here, a screw connection of the nozzle on or in the housing 7 by means of screws 18 is provided. The water leaves the nozzle in the direction of the arrow. The screws are disposed on the side which faces away from the slab—and thus protected from the radiant heat.

A seal 19 produces a tight joint between the nozzle body and the nozzle plates 9 and 10.

A toothing or profile 20, respectively, which exists between the nozzle body and the nozzle plates 9, 10 in order to hold the nozzle plates 9, 10 in a form-fitting manner and thus with a defined and reproducible seat in the nozzle body, is yet to be mentioned.

It can be seen in FIG. 3 that the outlet 4 of the nozzle 3 is configured so as to be readjustable with respect to the width b. To this end, the one nozzle plate 10 is disposed so as to be displaceable in the direction of the double arrow (the displacing means are not illustrated; these may be mechanical, hydraulic, pneumatic, or electric actuators).

Alternatively to FIG. 3, in FIG. 4 the one nozzle plate 10 is displaceable in the normal direction N onto the slab surface. On account thereof, the gap size of the rectangular gap of the nozzle 3 may also be modified.

Furthermore alternatively, although this is not illustrated, it may also be provided that a displacement of the one nozzle plate 10 in relation to the other nozzle plate 9 in the transverse direction to the conveying direction F, that is to say in the direction of the slab width, takes place, for example in order to cause a modification of the gap width right up to the complete closure of the nozzle 3 in the case of a conical section of the delimiting edge 11 of the nozzle plate.

It can be seen in FIGS. 5 and 6 that the outlet 4 of the nozzle 3 does not necessarily have to be linear (straight), but may also be configured in a curved manner. The outlet 4 of the nozzle 3 projects somewhat laterally beyond the width B of the slab 1. The arrows in FIG. 5 indicate the direction of flow of the water.

### LIST OF REFERENCE SIGNS

1 Slab/Preliminary strip
2 Descaling device
3 Nozzle
4 Outlet of the nozzle
5 Jet
6 Moving means
7 Housing
8 Portion/Protrusion
9 Nozzle plate
10 Nozzle plate
11 Delimiting edge
12 Supply line
13 Filter element (filter plate/filter housing/filter unit)
14 Jet director
15 Nozzle straightener path
16 Conveyor roller (roller table roller)
17 Deflection plate
18 Screw
19 Seal
20 Toothing/profile
21 Distributor duct
A Pivoting axis
B Width of the slab or of the preliminary strip
F Conveying direction
N Normal direction onto the surface of the slab or of the preliminary strip
a Spacing between the outlet of the nozzle and the surface of the slab or of the preliminary strip
a′ Spacing between lower edge of the portion/protrusion and surface of the slab or of the preliminary strip
b Width of the outlet of the nozzle in the conveying direction
p Pressure
α Angle

1-19. (canceled)

20. A method for cleaning and/or descaling a slab or a preliminary strip with a descaling device, wherein the descaling device has at least one nozzle having a rectangular outlet which is normal to a surface of the slab or of the preliminary strip and by way of which water under pressure is deployed onto the surface of the slab or of the preliminary strip, the method comprising the steps of:
configuring the outlet of the nozzle, when viewed in the direction normal to the surface of the slab or of the preliminary strip, alternatively to the rectangular outlet, to be slot-shaped with a curved profile at least in portions, so that the water in both configurations of the nozzle is deployed as a continuously strip-shaped jet across an entire width of the slab or of the preliminary strip;
selecting a width of the outlet of the nozzle in the conveying direction of the slab or of the preliminary strip to be between 0.2 mm and 1,5 mm;
supplying the water to the nozzle at a pressure between 5 bar and 50 bar; and
selecting a spacing between the outlet of the nozzle and the surface of the slab or of the preliminary strip to be between 8 mm and 50 mm.

21. The method as claimed in claim 20, including selecting the width of the outlet of the nozzle in the conveying direction of the slab or of the preliminary strip to be between 0.3 mm and 0.8 mm.

22. The method as claimed in claim 21, including selecting the width of the nozzle outlet to be between 0.4 mm and 0.6 mm.

23. The method as claimed in claim 20, including supplying the water to the nozzle at a pressure between 10 bar and 40 bar.

24. The method as claimed in claim 23, including supplying the water to the nozzle at a pressure between 15 bar and 35 bar.

25. The method as claimed in claim 20, including selecting the spacing between the outlet of the nozzle and the surface of the slab or of the preliminary strip to be between 10 mm and 30 mm.

26. The method as claimed in claim 25, including selecting the spacing between the nozzle outlet and the surface of the slab or of the preliminary strip to be between 15 mm and 20 mm.

27. The method as claimed in claim 20, including aligning the strip-shaped jet against the conveying direction of the slab or of the preliminary strip at an angle between 0° and 30° to the direction normal to the surface of the slab or of the preliminary strip fixedly or adjustably within the angular range.

28. The method as claimed in claim 20, including aligning the strip-shaped jet at an angle between 15° and 25°.

29. The method as claimed in claim 20, including adjusting delimiting edges of nozzle plates defining the outlet of the nozzle to different spacings from the surface of the slab or of the preliminary strip.

30. A descaling device for cleaning and/or descaling a slab or a preliminary strip, comprising:
at least one nozzle having an outlet which, when viewed in a direction normal to a surface of the slab or of the preliminary strip, is configured to be rectangular and by way of which water under pressure is deployed onto the surface of the slab or of the preliminary strip, wherein the outlet of the nozzle, when viewed in the direction normal to the surface of the slab or of the preliminary strip, is configured, alternatively to the rectangular embodiment, to be slot-shaped having a curved profile at least in portions, wherein the outlet of the nozzle has a width in the conveying direction of the slab or of the preliminary strip between 0.2 mm and 1.5 mm; and,
moving means for adjusting spacing between the outlet of the nozzle and the surface of the slab or of the preliminary strip.

31. The descaling device as claimed in claim 30, and further comprising a housing that is pivotable about an axis which is disposed to be horizontal and transverse to the conveying direction of the slab or of the preliminary strip, the nozzle being accommodated in the housing.

32. The descaling device as claimed in claim 31, wherein at least one portion or protrusion is disposed on the housing so that in an intended use of the descaling device the portion or protrusion is disposed so as to be closer to the surface of the slab or of the preliminary strip than the outlet of the nozzle.

33. The descaling device as claimed in claim 30, wherein the outlet of the nozzle is formed by two nozzle plates that are disposed so as to be adjacent to one another, wherein at least one of the nozzle plates is disposed so as to be adjustable in the conveying direction of the slab or of the preliminary strip and/or in the direction normal to the surface of the slab or of the preliminary strip and/or transversely to the conveying direction of the slab or of the preliminary strip.

34. The descaling device as claimed in claim 30, wherein the outlet of the nozzle is formed by two straightedge-shaped nozzle plates disposed so as be adjacent to one another, wherein the two nozzle plates have delimiting edges for the passage of water, which, when viewed in the direction normal to the surface of the slab or of the preliminary strip, run at a lip angle to the horizontal direction, transversely to the conveying direction of the slab or of the preliminary strip, and wherein the two nozzle plates are configured so as to be adjustable in relation to one another in the horizontal direction, transversely to the conveying direction of the slab or of the preliminary strip.

35. The descaling device as claimed in claim 34, wherein the lip angle is between 1° and 5°.

36. The descaling device as claimed in claim 30, wherein the outlet of the nozzle is formed by two nozzle plates of arbitrary contour, wherein the two nozzle plates are adjustable relative to one another so that a gap width across a width of the slab or of the preliminary strip is modified in a non-uniform manner.

37. The descaling device as claimed in claim 33, wherein the nozzle plates are composed of heat-resistant stainless steel, of tempered steel, of carbide metal, or of ceramic.

38. The descaling device as claimed in claim 30, further comprising a nozzle unit having the following components: a water-supply region, a filter plate, a jet director, a nozzle compensation path, a jet concentration in front of a nozzle gap, and the nozzle gap.

39. The descaling device as claimed in claim 30, wherein the width of the outlet of the nozzle is adjustable in portions in the conveying direction across the width of the slab or of the preliminary strip.

40. The descaling device as claimed in claim 30, and further comprising at least one filter element that has a plurality of bores, meshes, or slots, wherein the bore diameter, the mesh aperture, or the slot width is smaller than or of an equal size to the width of the outlet of the nozzle,

41. The descaling device as claimed in claim 40, wherein the filter element is disposed in front of an outlet region of the nozzle, wherein a sum of cross-sectional areas of the bores, meshes, or slots in the filter element is larger than a cross section of the outlet of the nozzle.

42. The descaling device as claimed in claim 30, further comprising water supply lines composed of a rust-proof material

43. The descaling device as claimed in claim 30, wherein the nozzle in an outflow direction of the water has a conical outlet gap or a parallel outlet gap, wherein the outlet gap has a length, when measured in the outflow direction of the water, less than 20 mm and/or longer than three times a width of the outlet of the nozzle.
